(19) United States
(12) Patent Application Publication
(10) Pub. No.: US 2026/0296833 A1
(43) Pub. Date: Oct. 1, 2026

(54) Elevator Traction Media Monitoring

(71) Applicant: INVENTIO AG, Hergiswil (CH)

(72) Inventor: Philippe Henneau, Zürich (CH)

(21) Appl. No.: 19/479,513

(22) PCT Filed: May 6, 2024
(86) PCT No.: PCT/EP2024/062447

§ 371 Date: Oct. 28, 2025

(30) Foreign Application Priority Data
May 9, 2023 (DE) 102023112084.0

(51) Int. Cl. B66B 7/12; B66B 1/34; B66B 3/00; B66B 5/12; B66B 11/00; B66B 11/04

(52) U.S. Cl. CPC B66B 7/1215; B66B 1/3476; B66B 1/3492; B66B 3/002; B66B 5/12; B66B 11/004; B66B 11/043

(57) ABSTRACT

The present disclosure relates to elevator technology, and more particularly determining deterioration of a traction medium in an elevator system and monitoring the elongation of a traction medium in an elevator system over time. The elevator system comprises an elevator car, a counterweight, and at least one traction medium connecting the elevator car and the counterweight. The elevator system is adapted to determine a position of the elevator car and the counterweight within the elevator shaft, wherein the position is an absolute position of at least one of the elevator car and the counterweight within the elevator shaft, wherein the absolute position is determined upon determining that the elevator car and the counterweight are in a defined position within the elevator shaft relative to one another, and wherein from the absolute position, an absolute length and/or a relative elongation of the traction medium is determined.

### TECHNICAL FIELD

The present disclosure relates to elevator technology. In particular, the present disclosure relates to determining a deterioration of a traction medium in an elevator system. Further in particular, the present disclosure relates to monitoring the elongation of a traction medium in an elevator system over time.

### BACKGROUND

The present disclosure relates to the monitoring of traction media in an elevator system. In a conventional elevator system, an elevator car is operated in an elevator shaft and serves the individual floors of the elevator installation. The elevator car is regularly suspended in the shaft by one or more traction means attached to a counterweight at its opposite end. An elevator machine or drive motor actuates the traction media, e.g. by turning a drive sheave, which in turn moves the traction media. Rotation of the elevator machine, and hence the drive sheave, moves the elevator car up or down the elevator shaft, its weight being counterbalanced by the counterweight. Traction medium may be steel ropes, synthetic ropes or belts.

In an exemplary elevator system having the elevator machine at the top of the elevator shaft, both the elevator car and the counterweight are suspended by the traction medium within the elevator shaft. As such, the traction media are the primary support for both the elevator car and the elevator counterweight within the elevator shaft. Certain means may be provided to prevent the car and/or counterweight from falling freely within the shaft in the event of a failure of the traction means. Such means may be emergency brakes which are applied in the event of a free fall situation, i.e. a situation in which the car and/or the counterweight exceeds a pre-defined maximum travelling speed. However, such emergency brakes are only a last resort, as reactivation of the elevator system after the engagement of the emergency brakes may be a complicated, time-consuming and costly operation, during which the elevator system may be out of service for an extended period of time.

### SUMMARY

Thus, there may be a need for monitoring the correct functioning of the traction media.

Further, there may be a need for establishing a level of deterioration of the traction media to avoid accidental and unanticipated failure of the traction media.

Still further, there may be a need for a universal monitoring methodology independent of the geometry and the material of its tensile strength.

Still further, there may be a need to detect degradation of the traction media before a traction medium ruptures or becomes slack.

EP 4 065 499 A1 describes a method and a monitoring apparatus for determining a wear state of components such as a rope-like suspension means, a sheave of a prime mover and pulleys of a suspension means arrangement of an elevator system. For example, a length measuring sensor is provided at a lower end of the lift shaft in the vicinity of a buffer adjacent to a travel path of the counterweight. With the aid of this length measuring sensor, a distance between the counterweight and the buffer can be determined when the counterweight is at its lowest possible position, i.e. when the car is at the highest possible floor. Indirectly, the measurement of this distance can be used to draw conclusions about a current length of the support means, which can change over time, in particular due to material stretching. The described technical concept requires that cabling is provided from the top and throughout the elevator shaft to the bottom of the elevator shaft, which is complicated to install and maintain, which increases the cost of the elevator system and is prone to early defects. Also, with varying length of the suspension means, the elevator car and the counterweight are not at a defined position but at varying positions relative to one another.

At least one such need may be met by the subject matter of the independent claims. Preferred embodiments are provided in the dependent claims and are explained in detail in the following description.

The present invention relates to traction media monitoring.

According to a first aspect of the disclosure, there is provided an elevator system, comprising an elevator car, a counterweight, and at least one traction medium connecting the elevator car and the counterweight, wherein the elevator system is adapted to determine a position of the elevator car and the counterweight within the elevator shaft, wherein the position is an absolute position of at least one of the elevator car and the counterweight within the elevator shaft, wherein the absolute position is determined upon determining that the elevator car and the counterweight are in a defined position within the elevator shaft relative to one another, and wherein from the absolute position, an absolute length and/or a relative elongation of the traction medium is determined.

According to a second aspect of the disclosure, there is provided a method of monitoring a traction medium of an elevator system, wherein the elevator system comprises an elevator car, a counterweight, and at least one traction medium connecting the elevator car and the counterweight, the method comprising the steps determine a position of the elevator car and the counterweight within the elevator shaft, wherein the position is an absolute position of at least one of the elevator car and the counterweight within the elevator shaft, determine that the elevator car and the counterweight are in a defined position within the elevator shaft relative to one another, and determine, from the absolute position, an absolute length and/or a relative elongation of the traction medium.

Preferably, the elevator system further comprises a position determining system having a position sensor arranged on each of the car and the counterweight to measure absolute position of the elevator car and/or the counterweight within the shaft. The position sensor being one of a camera or a hall sensor for reading position codes from a code tape. The code tape being arranged within the hoistway along the pathway of the elevator car and the counterweight. Alternatively, the position sensor may be a laser distance measuring sensor for measuring the distance between the elevator car respectively the counterweight and a upper or lower end of the hoistway.

Absolute position of the elevator car and or counterweight is the current position within the shaft that can be determined continuously during travelling of the elevator car and/or counterweight at any location within the hoistway, also between elevator car stop positions at a story of a building. In more traditional elevator systems only at defined positions within the hoistway, normally at stop positions, a car position is determinable.

One solution for a device that may monitor the elongation of various types of traction media in elevators is to use strain gauges. Such devices may be attached to the traction media and measure the amount of deformation or elongation that occurs over time. Strain gauge data may be transmitted to a monitoring system for analysis and monitoring. Another solution may be to use sensors, e.g., as optical sensors or ultrasonic sensors which can measure the distance between two points on the rope or belt, and hence calculate an elongation. Such sensors may be calibrated to work with different types of elevators and different types of traction media.

Such a solution of using strain gauges or sensors to measure the elongation of traction media may also be applied to the counterweight side of the elevator. Strain gauges or sensors may be attached to the traction media at the counterweight essentially in the same way as they would be attached to the elevator car side. This may allow for monitoring and measurement of elongation on both sides of the elevator system, providing a more complete picture of the elevator's performance and helping to ensure that the system is operating safely and efficiently. Preferably, the sensors are placed such that they are not affected by the car or counterweight movement and that they are able to measure the elongation of the traction media.

Such a solution may in particular work to measure a single traction medium but not if all traction media elongate in the same manner over time. If all traction media in the elevator system elongate at the same rate, then measuring the elongation of one rope or belt may not provide a complete picture of the elevator system's performance. In order to ensure that the monitoring system is accurate and effective, it may be beneficial to install multiple strain gauges or sensors on different traction media within the elevator system. Additionally, or alternatively, a monitoring system that tracks the elongation of multiple traction media in real-time, and compares the data from each media may identify any discrepancies, which may indicate an issue with the elevator system. This may help to quickly identify and address any problems, and ensure that the elevator system is operating safely and efficiently. Another alternative is to use sensors that are able to measure the load or tension on the traction media, rather than measuring the elongation directly. This way, if all the media elongate the same way, the monitoring system will still be able to detect any uneven distribution of load across the traction media.

In the context of elevator traction media elongation monitoring, strain gauges and load or tension sensors are two possible types of devices that may be used to measure the performance or status of the elevator system. A strain gauge is a device that measures the deformation or elongation of a material, such as an elevator traction media. It works by converting the mechanical strain of a material into an electrical signal, which may then be read by a monitoring system. Strain gauges are typically attached to the traction media in a specific location, and measure the change in length or width of the material as it elongates. A load or tension sensor measures the force or weight that is applied to a material, such as an elevator traction media. It works by converting the force or weight into an electrical signal, which can then be read by a monitoring system. Load or tension sensors can be installed in different points of the traction media, and measure the force or weight that is applied on the traction media.

In summary, strain gauges measure the elongation of a material, whereas load or tension sensors measure the force or weight applied on a material. Both types of sensors may be used to monitor the performance of an elevator system, while providing different types of information. Both strain gauges and load or tension sensors may help to identify issues related to elongation and wear of the traction media, and may help to identify issues related to uneven distribution of load or tension across the traction media.

However, regularly, strain gauges typically measure the elongation of a material over a small area or at a specific point. It is difficult to measure the elongation of the entire length of an elevator traction media using a single strain gauge, as the strain gauge would need to be placed along the entire length of the traction media. However, it may be possible to install multiple strain gauges along the length of the traction media, to measure the elongation at different points, as this may provide a more accurate picture of the elongation of the whole traction media. Additionally, the data from multiple strain gauges may be collected and analyzed collectively, to provide a more comprehensive understanding of how the elongation of the traction media is changing over time and where issues may be occurring. Another approach may be to use a noncontact sensor, such as an optical sensor or ultrasonic sensor, which may measure the distance between two points on the rope or belt, and hence determine a length, and subsequently an elongation as a change in length over time. Such a sensor may be placed at one end of the traction media and determine the distance from the other end, which allows for measuring the length and thus elongation of a larger part or the whole of the traction media.

However, using multiple strain gauges over the length of a traction media may prove difficult. When the traction media gets in contact with the traction sheave, it may be under pressure and be damaged or destroyed. Moreover, connecting them electrically to the monitoring device may prove difficult. A more practical solution would be to install a small number of strain gauges at strategic points along the length of the traction media, e.g., at these points where they will be protected from damage but may still provide useful information about the elongation of the traction media. For example, gauges may be placed on the traction media at points where the traction media are most likely to experience wear or elongation, such as near a pulley or at a location where the traction media is anchored, e.g., to the building, the elevator car and/or the counterweight. Alternatively, a gauge maybe arranged at a fix point in a 2:1 hoisting arrangement.

Another option, as mentioned before, is to use non-contact sensors such as optical or ultrasonic sensors. Such sensors may be placed at one end of the traction media, and measure the distance to the other end, thus measuring the elongation of the whole rope or belt without being in contact with it, thus avoiding any damage risk. Further, the load or tension sensors may be used to complement elongation monitoring. By measuring the load or tension in the traction media, any issues related to uneven distribution of load or tension across the traction media may be detected, and it may be detected if one traction medium is elongating more than the others.

Another type of monitoring is implemented as a slack contact to ensure that the traction media are not too loose or not broken. While such a device may only detect the fully broken state of a traction media or a slack traction media indicating an unbalance of the load between the traction media, such may not correspond to a terminal failure as a conventional elevator system may be designed with sufficient redundancy in the traction media. Thus, it may be beneficial to anticipate such a fault situation by monitoring the elongation of the traction media, and predict when a fault is increasingly likely or even imminent.

The condition of a traditional traction media such as the metallic rope is traditionally verified by the mean of a visual check along its whole length. The prescribed methodology by code is to count the number of broken thin wires producing the ropes. A traction media rope is considered as worn when the number of broken wires per meter exceeds a limit given by a particular elevator county code. However, such methodology doesn't work with non-metallic tensile member or with coated metallic member.

Examples of common techniques used to control the traction media are:

TABLE 1

| Geometry/tension | Metallic tension | Non-metallic tension |
|---|---|---|
| member material | member | member |
| Circular uncoated: | Visual check | Carbon indicator |
| | Magnetic flux | in the rope |
| Flat or circular | Electrical | Measurement of |
| coated: | measurement | elongation of |
| | of the tension | one traction |
| | members | medium |
| | Magnetic flux | (deviation over |
| | | time, correlation |
| | | with car load) |
| | | Measure other |
| | | mechanical |
| | | properties such |
| | | a vibration |

Image processing of traction media images to detect (visible) changes of the traction media is a further option for traction media monitoring. However, a visual check or image processing may be seen as time consuming, and may only be done only periodically. The whole length of the traction media may be difficult to monitor, e.g., due to the accessibility of the traction media, and hidden damages may not be readily visible (e.g., corrosion in the center of a particular traction medium.

To perform traction media monitoring with magnetic flux may require that the device is fixed there where the traction media are in movement, e.g., after/before the traction sheave, resulting in a limited exposure of the traction media to the device. Such a device may in particular be a portable device, and thus does not provide a constant monitoring, but only an on demand monitoring during a maintenance visit. The whole length may be difficult to monitor (accessibility of the traction media), and it works mainly for metallic core traction media.

Electrical traction media monitoring requires delicate techniques to connect the measurement device to each tensile member on both sides of the traction media. The electrical properties of metallic tension member are influenced by environment factors such as temperature, requiring compensation by the mean of additional sensor. In case of an elongation of a single or a subset of traction media, a correlation of the load in the car may be required to make a correct determination assessment.

The current disclosure is about comparing the car position with a known position of the counterweight, for example when the elevator car crosses the counterweight in the central region of the shaft. Comparing the position of the elevator car and/or the counterweight at the point in time of crossing or passing, allows collecting position data over an extended period of time. In other words, a change in length of the traction is detected by detecting a change of the car absolute position at the point in time there where the counterweight meets the car. The position data can be compared, and a trend may be derived from the position data. E.g., a gradual shift of the passing position may indicate a gradual elongation of the traction media over time. Such a gradual elongation may be acceptable and within the design parameters of an elevator system. Alternatively, or additionally, a determined elongation may be indicative of an ongoing malfunction of the elevator system, for example in case the elongation occurs with a particular trend exceeding a predefined threshold. In other words, in case it is determined that the elongation is occurring with a rate that is higher than an anticipated rate over the lifetime and/or trip count of the elevator system, an external factor may be assumed, influencing or negatively impacting the operation of the elevator system. In this scenario, in case the elevator system is determining that the elongation over time is exceeding the threshold, an off-plan maintenance visit to the elevator system may be scheduled, to determine the cause of the excessive elongation. Thus, a service technician may visit the elevator system between normal schedules, to check whether a particular maintenance procedure needs to be initiated. Thereby, downtime of the elevator system may be avoided by only scheduling maintenance visits when an abnormal operation is detected. Such is referred to as predictive maintenance.

The elevator system may additionally determine a current carrying capacity or occupancy of the elevator car, in other words, a current load or weight of the elevator car, which in turn may result in an extraordinary, in particular, additional, elongation of the traction media due to the additional weight. The ascertained weight of the elevator car may be used to compensate a determined elongation so to normalize a measurement. The weight compensation of the elongation measurement may allow to provide a more reliable elongation determination, as it removes elongation effects due to the current loading of the elevator car.

Traction media, which also play the role of suspension means, come in a variety of embodiments that differentiate in their geometry, the core tensile material and optionally a coating material. Most commonly used are circular geometry type traction media with a metallic core, commonly called steel ropes, and flat traction media, commonly using belts consisting of thin steel cords coated in polyurethane, rubber or the like. The properties of a traction medium, such as its tensile strength, depends mostly on the material of the tension member. Recent development lead to new types of traction media consisting of coated tensile member. Example of combination of traction media geometry and material used. The traction media are essential for the safety of the elevator, and it is therefore beneficial to monitor their state and condition.

In an elevator system, a defect of a traction media causes degradation of the performance of the said traction media. It is uncommon to have corrosion impacting the same way all the traction member of one elevator. Instead, each traction media will depict various difference in their performance at various positions. Any defect leads to a change of the tensile strength of a traction media, it will decrease. The reduction of the tensile strength leads to a higher elongation of the traction media and ultimately the traction media will break. An elevator system conventionally has a plurality of traction media; if one traction medium elongates, the load will be rebalanced to the remaining shorter traction media. The excessive elongation or breaking of a traction media is detected by a slack contact at the fix point where it is attached to. The rupture of a traction media may cause serious damages; it is therefore beneficial to prematurely detect defects before a rupture. Deviation of the length of the traction media (under the same load condition) is an indicator of its performance degradation. However, a traction media also elongates naturally when constantly loaded. There are various ways to detect the elongation of a traction media. Difference of the load measured at the fix point of each traction media, can indicate difference in the length of one of them (longer a traction media is compared to the other traction media in the same set, less load it will bear, and the load will be distributed to the remaining shorter traction media). Such measurement is known to be unreliable due to the effect of friction which naturally leads to a difference between the load on each traction media during travel.

The elongation of traction media in elevator system is a known phenomenon. Since traction media are always under load condition, a natural elongation occurs after their installation, especially in high-rise buildings. The choice of pre-stretched traction media may reduce but not eliminate the amount of elongation of newly installed elevator traction media. Traction media with little elongation do not need to be shortened as soon after installation. The elongation of traction media must be monitored to avoid situations in which the counterweight would reach and touch the bottom of the shaft before the car reached its highest position in the shaft.

The present disclosure relates to monitoring the full length of all traction media by determining their elongation via their current length between their end points.

Modern elevators consist of a drive system which makes use of an absolute positioning to precisely position the car at a building floor. Different technologies of absolute position measurement exist. Conventionally, all allow a position determination with a precision in the order of one or a few millimeters. The proposed methodology consists of comparing over time the position of the elevator car when the counterweight is at a known position. Such a known position may e.g. be when the elevator car meets the counterweight in the shaft. In other words, a known position may be a position where the elevator car is at a defined position relative to the counterweight. Put another way, a defined point in time where the elevator car and the counterweight are relative to one another, which may be repeated with high position may be sufficient for the elongation determination. The positioning itself may be of less relevance. A particular simple means of determining the defined position and thus the defined point in time when taking the measurements, i.e., determining the absolute position of the elevator car and/or the counterweight, may be when the elevator car and the counterweight are passing one another. Such a passing may be determined when e.g. the top of both the counterweight and the elevator car are at the same height in the elevator shaft. Alternatively, a passing may be determined when e.g. the bottom of both the counterweight and the elevator car are at the same height in the elevator shaft. Other relative positions are conceivable, as long as the relative position is repeatable with high position.

At the point in time where the elevator system determines that the elevator car and the counterweight are at the defined position relative to one another, and absolute position of the elevator car and/or the counterweight may be determined. By determining a change over time of said absolute position, a trend in the elongation of the traction media may be determined.

A particular current length of the traction media may thus be related to two conditions, the car load and the elongation of the traction media over time. The current length of the traction media may be due to the natural elongation of the traction media over the operation time of the elevator system and due to a particular defect of one or more or all of the traction media of the elevator system.

Thus, when the elevator system determines a particular absolute position of e.g., the elevator car, related to a defined point in time where the elevator car and the counterweight are at a relative position to one another, the elevator system may compare said particular absolute position with historical absolute position data. From said comparison, a change of the length of the traction media over time may be determined and thus an elongation, a relative change of the length of the traction media over time. The determined absolute position, the derived length of the traction media or the determined elongation may be compensated by the elevator car load. The elevator car load may correspond to a specific weight of the elevator car due to passengers and/or cargo being present in the elevator car at the time of passing of the elevator car and the counterweight. Since a specific elevator car load/weight of the elevator car results in an additional temporary elongation of the traction media, the absolute position where the elevator car and the counterweight are passing one another is influenced as well. With the knowledge about the elevator car loads, the determined absolute position may be compensated, e.g., to correspond to a comparable absolute position of an unloaded elevator car. Thereby, the determined absolute positions may be normalized with regard to a defined state of the elevator car, as mentioned e.g., the unloaded elevator car. By normalizing the determined absolute position with regard to the elevator car load, the position of the elongation determination may be increased.

Alternatively, in case an elevator car load may not be determined for each trip, e.g. because the elevator system does not comprise a suitable load sensor, a reference trip may be conducted where the elevator car is in a known condition. For example, a trip may be conducted at a defined point in time, where it is safe to assume that the elevator car is loaded. E.g., it is conceivable that the elevator system performs a trip at 3 o'clock in the morning each day with no moving having occurred at least 10 minutes prior to said trip. Such a trip condition may allow the safe assumption that the elevator car is in an and loaded condition. Since a fault regularly does not occur instantaneously, conducting such a trip once per day may allow normalization parameters to a sufficiently precise and secure extent.

By recording historic absolute position information when the elevator car is at a defined position relative to the counterweight, preferably normalized information, allows a statistical analysis of the absolute crossing position. By statistical analysis of the change of the absolute position or the normalized absolute position over time, a trend of the change of length of the traction media may be determined and thus an elongation over time. Said determined elongation over time may be compared with an expected elongation over time to verify that the elevator system is operating as expected or whether the current elongation indeed exceeds the expected elongation at that point in the lifetime of the elevator system or the traction media set. The expected elongation at that point in the lifespan of the elevator system may be influenced by the total number of trips, the age of the elevator system/the traction media and/or a particular load profile of the elevator trips.

A load profile may in particular consider in what load condition the elevator car was over the total number of trips.

It may in particular be sufficient to have absolute position knowledge of only the elevator car and the elevator counterweight, specifically, as long as a defined point in time is detectable where the elevator car and the elevator counterweight are at a relative position to one another. One such position may be the passing of the elevator car and the counterweight. E.g., such a defined point in time may be when the elevator car top side and the elevator counterweight top side are at the same height within the elevator shaft. Likewise, it is conceivable that the defined point in time may be when the elevator car bottom side and the elevator counterweight bottom side are at the same height within the elevator shaft. Any arbitrary defined relative position of the elevator car and the counterweight may be employed as long as the defined relative position is detectable with sufficient precision. Sufficient precision may e.g. be when the elevator car and the counterweight are at a defined relative position to one another with a position of 1 mm, 2 mm, 3 mm, 4 mm, 5 mm, 6 mm, 7 mm, 8 mm, 9 mm, 1 cm, 1.5 cm, 2 cm, 3 cm, 4 cm, 5 cm, 6 cm, 7 cm, 8 cm, 9 cm or 10 cm. This precision is independent from the precision of the absolute position determination within the shaft. The point in time where the elevator car and the counterweight are at a defined relative position to one another may in particular correspond to the point in time where the reading of the absolute position within the elevator shaft of one of the elevator car and the counterweight is performed. The precision of the determination of the relative position to one another may not change throughout the lifetime of the elevator system.

Accordingly, the relative position determination means, in other words means to determine the relative position of the elevator car and the counterweight, may be required to maintain their position throughout the lifetime of the elevator system. The relative position determination means may be required to determine the relative position in a reliable and repeatable manner. From the trend of the change of the absolute position of the elevator car and/or the elevator counterweight within the shaft over time, an elongation and thus a degradation in the performance of the traction media may be deduced. A part of the trend/the resulting elongation over time may be attributed to a certain number of trips and/or a certain expected elongation over time due to normal fatigue or the like. In case a determined elongation or trend is within this expected elongation, a normal operation of the elevator system may be assumed. In case a determined elongation or trend is exceeding the expected elongation, such may be an indication of an abnormal operation of the elevator system.

Such an abnormal operation, when determined by the elevator system, may be signaled to an external third party. For example, it may be signaled to the manufacturer of the elevator system and/or a company tasked with the maintenance of the elevator system. The third party may then analyze the received information and may decide whether a reaction is required. Such a reaction may be an unscheduled maintenance visit or initiating a repair of the elevator system. It is likewise conceivable that the analysis of the determined position information is not performed within the elevator system but by the third party. Here, the third party periodically may be sent information about the current absolute position when the elevator car and the counterweight are in the defined position relative to one another and/or the current elongation. Still further, it is conceivable that the third party provides the elevator system with updated information of what is considered an app normal elongation throughout the lifetime of the elevator system. In other words, e.g., it is conceivable that what is considered an abnormal elongation changes over time due to a change in the underlying information. With receiving such external information or updates, the elevator system may adapt its behavior to the most current threshold information obtained.

According to an embodiment of the present disclosure, the absolute positions of the elevator car and the counterweight in the elevator shaft may be determinable independently.

Since it may be sufficient that only one absolute position of the absolute position of the elevator car and the counterweight is used for determining the trend or the elongation itself and consequently, it may not be necessary to determine the absolute position of both the elevator car and the counterweight.

According to a further embodiment of the present disclosure, the defined position of the elevator car and the counterweight relative to one another may be the position when the elevator car and the counterweight are passing one another in the elevator shaft.

Having the elevator car and the counterweight in close proximity to one another, e.g., when passing one another, in the elevator shaft, may facilitate the determination of the relative position of the elevator car and the counterweight relative to one another. Passing may in particular be understood as the elevator car and the counterweight being at the same height in the elevator shaft or are level with one another in the elevator shaft.

According to a further embodiment of the present disclosure, the elevator system may further comprise a motor arrangement comprising a traction sheave for moving the elevator car and the counterweight in an elevator shaft, wherein the traction sheave is arranged for actuating the at least one traction medium, in particular wherein the elevator car and the counterweight are suspended in the elevator shaft from the traction sheave by the at least one traction medium.

Having an elevator system where the elevator car and the counterweight are suspended within the elevator shaft by hanging from the motor arrangement/the traction sheave respectively facilitates a determination of an elongation of the traction media. In this scenario, it is conceivable that both the elevator car and the counterweight are affixed to the traction media at their respective and accordingly, the traction media are loaded by the elevator car and the counterweight across substantially their complete length. The same applies when the elevator car and/or the counterweight are moved by the traction media using pulleys or being underslung, in other words when one or both ends of the traction media are affixed to the building structure.

According to a further embodiment of the present disclosure, the elevator system may further comprise a sensor arrangement for determining that the elevator car and the counterweight are in a defined position within the elevator shaft relative to one another.

According to a further embodiment of the present disclosure, the sensor arrangement may be provided on at least one of the elevator car and the counterweight.

Such a sensor arrangement may in particular may be attached to one of the elevator car and the counterweight and may detect the presence of the respective other one of the elevator car and the counterweight. In case of sufficient precision in the presence detection, said information may be employed to determine a specific point in time to acquire a measurement of the absolute position of the elevator car and/or the counterweight within the elevator such as, which is repeatable in a reliable manner.

According to a further embodiment of the present disclosure, the sensor arrangement may comprise a first part provided on the elevator car and a second part provided on the counterweight, and the first part and the second part may be arranged to interact to determine the defined position of the elevator car and the counterweight within the elevator shaft relative to one another, in particular the passing of the elevator car and the counterweight within the elevator shaft.

According to a further embodiment of the present disclosure, the first part may be emitting a sensor signal and the second part may be receiving the sensor signal, or the first part may be emitting and receiving a sensor signal and the second part may be reflecting the sensor signal back towards the first part of the sensor arrangement.

According to a further embodiment of the present disclosure, a passing of the elevator car and the counterweight may be determined by emitting a sensor signal from a first part of a sensor arrangement, and receiving the sensor signal by a second part of the sensor arrangement, or emitting a sensor signal from a first part of a sensor arrangement, reflecting the sensor signal by a second part of the sensor arrangement back towards the first part of the sensor arrangement, and receiving the sensor signal by the first part of the sensor arrangement.

According to a further embodiment of the present disclosure, the sensor signal may be at least one signal out of the group consisting of a visual signal, an infrared signal, a laser signal, an electromagnetic signal, an RFID signal, an NFC signal, an electrical signal, a contact signal and an acoustic signal.

By having a two-part sensor arrangement where the respective parts interact to determine a relative position of the elevator car and the counterweight allows a reliable and simple determination of the relative position of the elevator car and the counterweight relative to one another. In other words, the respective parts need to be at defined positions relative to one another to trigger the determination of the relative position and thus trigger the point in time when to acquire the absolute position of one of the elevator car and the counterweight.

Preferably, the detection that the elevator car and the counterweight are in a defined relative position to one another is limited to a very small time-window. E.g., in case the time window of detection that the elevator car and the counterweight are in close proximity is 0.1 seconds or less, the determination of the point in time where the proximity requirement is fulfilled may be determined with comparably high precision. Alternatively, or additionally, receiving only a single impulse signal when the elevator car and the counterweight are in a defined relative position to one another may be used as a trigger point to determine the absolute position.

Such a trigger signal may be provided by a sender on one of the elevator car and the counterweight and a receiver on the other counterweight or elevator car or by having a sender and receiver on one of the elevator car and the counterweight and a reflecting element returning the sensor signal. In particular returning the sensor signal may preferably be embodied as a rather short, impulse like return signal.

E.g., in case of a visual sensor, a light or laser source directed in the direction where the one of the elevator car and the counterweight is passing the effective other element may be detected by a respective receiver on the other element or may be reflected, e.g. by a mirror element or generally a reflecting element back to the sending element.

Alternatively, e.g. in case of a sound signal, a change in frequency may be employed for determining whether the elevator car and the counterweight are moving towards one another or away from one another. The point in time of the frequency change may be indicative of the time point where the elevator car and the counterweight are closest to one another. Such maximal proximity may be determined by employing the Doppler effect.

Still further, using a short-range communication element like a RFID or NFC communication element may allow a determination of proximity of the elevator car and the counterweight.

According to a further embodiment of the present disclosure, the determination of the absolute position of the elevator car and/or the counterweight, and the determination of the passing of the elevator car and the counterweight may be performed independent from one another.

In other words, the sensor arrangement may provide a trigger related to the proximity of the elevator car and the counterweight, which may generally be understood as an indication to take a measurement of the current absolute position of one of the elevator car and the counterweight. Independent from the determination of proximity of the origin car and the counterweight, the absolute position of one of the elevator car and the counterweight may be determined by separate means within the elevator shaft in other words, an absolute position system of the elevator system may be employed to determine the absolute position of one of the elevator car and the elevator shaft at the instance of proximity of the elevator car and the counterweight.

According to a further embodiment of the present disclosure, the elevator system further comprising a load sensor adapted to measure a current load of the elevator car, wherein the current load is used to compensate the determined absolute position, in particular the absolute position of the elevator car, for elongation variation of the traction medium depending on the current load of the elevator car. Preferably, such load sensors are arranged at the elevator car or the suspension points of the traction medium.

According to a further embodiment of the present disclosure, when it is determined that the absolute length and/or a relative elongation of the traction medium is exceeding a defined threshold value, the elevator system may be adapted to provide an indication or transmit a signal to third entity, and/or when it is determined that the absolute length and/or a relative elongation of the traction medium is exceeding a defined threshold value, the elevator system may be adapted to stop operation of the elevator system.

According to a further embodiment of the present disclosure, when it is determined that the absolute length and/or a relative elongation of the traction medium is exceeding a defined threshold value, the method may further comprise at least one of the steps of providing an indication, transmitting a signal to a third entity, and/or stopping operation of the elevator system.

In the event that the elevator system determines that the absolute length and/or the relative elongation of the traction Medium, thus relocation of the traction media over time exceeds a defined threshold value, the elevator system may signal the at least one of the manufacturer of the elevator system, a company tasked with the maintenance of the elevator system, the owner of the elevator system, the owner of the building the elevator system is installed in and relevant users of the elevator system accordingly. Alternatively, or additionally, in case the elevator system determines that the elongation exceeds a defined threshold, which may allow the assumption of an abnormal elongation of the traction media, the operation of the elevator system may be shut down. The threshold value may change over time, in particular increase, e.g. may be dependent on a number of conductive strips, an age of the elevator system and/or further parameters. E.g., a threshold value with X trips and Y months of age may be smaller than a threshold value after 10×X trips and/or 10×Y months of age.

### BRIEF DESCRIPTION OF THE DRAWINGS

The present invention will now be described with reference to the accompanying drawings, in which:

FIG. 1 shows an exemplary elevator system according to the present disclosure.

FIGS. 2a and 2b show exemplary absolute positions of the elevator car and the counterweight within the elevator shaft when at a defined position relative to one another according to the present disclosure.

FIGS. 3a-3c show exemplary embodiments of sensors arrangements according to the present disclosure.

FIG. 4 shows a trend graph of the change of the absolute position at the time of being in the defined relative position to one another of the elevator car and the counterweight.

### DETAILED DESCRIPTION OF EMBODIMENTS

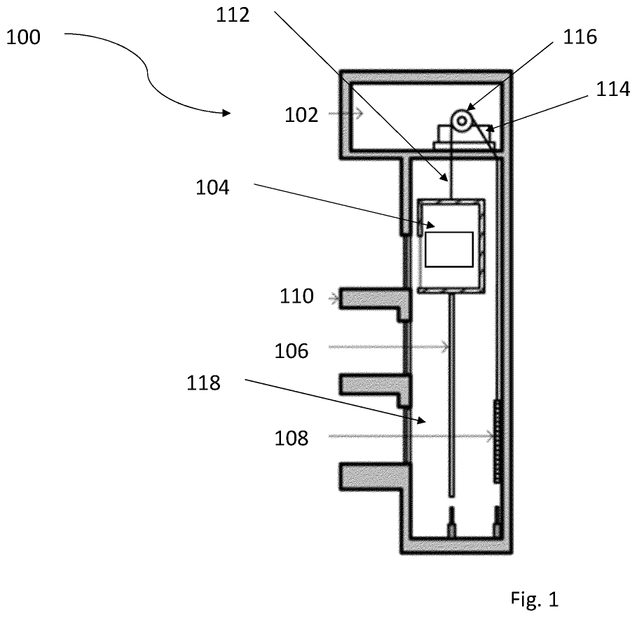

Now referring to FIG. 1, which shows an exemplary elevator system 100 according to the present disclosure.

FIG. 1 shows a conventional elevator system 100 comprising of an elevator car 104 arranged in an elevator shaft 118. The elevator car 104 is suspended by one or more traction media 112 and guided within the shaft 118 by guide rails 106. The elevator car 104 is arranged to serve as a plurality of floors 110, in the exemplary elevator system 100 of FIG. 1, three floors 110. The elevator car 104 is affixed to the traction media 112 at one end of the traction media 112. A counterweight 108 is affixed to the traction media 112 at the other end of the traction media 112.

The elevator system 100 of FIG. 1 exemplarily comprises a machine room 102, where a motor 114 is arranged, driving a traction sheave 116. By operating, i.e., powering, the motor 114, the traction sheave 116 is rotated, thereby actuating the traction media 112. Operation of the motor 114 and thus actuation of the traction media 112 by traction sheave 116 moves the elevator car 104 within the elevator shaft 118, specifically lowers or raises the elevator car 104.

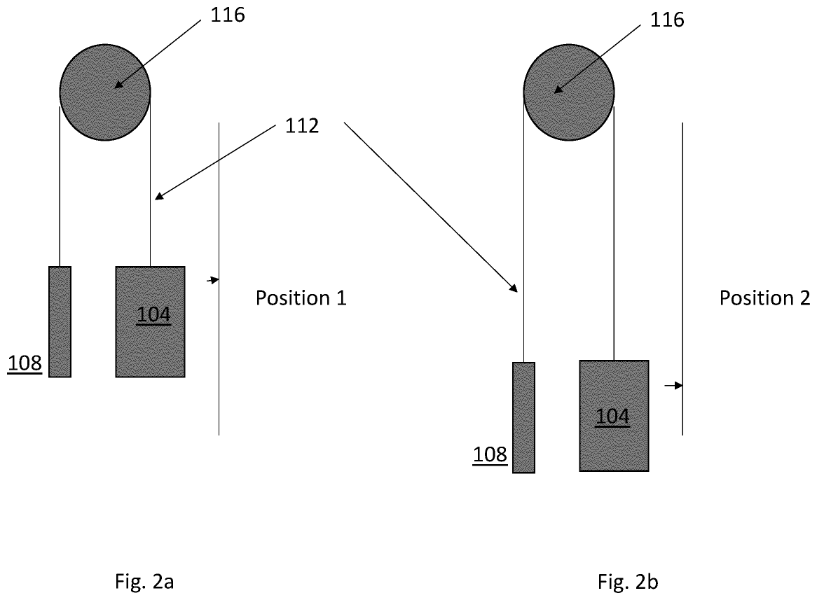

Now referring to FIGS. 2a and 2b, which show exemplary absolute positions of the elevator car 104 and the counterweight 108 within the elevator shaft 118 when at a defined position relative to one another according to the present disclosure.

FIGS. 2a and 2b show the elevator system 100 only in a simplified manner by the depicted elevator car 104 and the counterweight 108 suspended from traction sheave 116 by traction media 112. In both FIGS. 2a and 2b, the elevator car 104 and the counterweight 108 are at a defined position relative to one another in that they are level or at the same height within the elevator shaft 118, e.g. when passing one another within the elevator shaft 118.

The absolute position in FIG. 2a, “Position 1”, is determined at the defined point in time when the elevator car 104 and the counterweight 108 are at the defined position relative to one another. The absolute position in FIG. 2b, “Position 2”, is determined at the defined point in time when the elevator car 104 and the counterweight 108 are at the defined position relative to one another, but later in the lifespan of the elevator system 100. As can be seen, Position 2 is lower in the elevator shaft 118 than Position 1. This means that the traction media 112 in FIG. 2b has elongated compared to the status of the traction media 112 in FIG. 2a. By comparing Position 1 and Position 2, and elongation of the traction media 112 may be calculated. E.g., in the case where Position 2 is e.g., 5 cm lower in the elevator shaft 118 than Position 1, this can be calculated to an elongation of the traction media 112 of 10 cm. Since both the elevator car 104 and the counterweight 108 are 5 cm lower in the elevator shaft 118, the total elongation approximates twice the position difference.

The elevator system 100 may then determine whether the determined elongation is still within safety parameters of the elevator system 100 or whether the elongation is exceeding the safety threshold and thus appropriate measures need to be initiated.

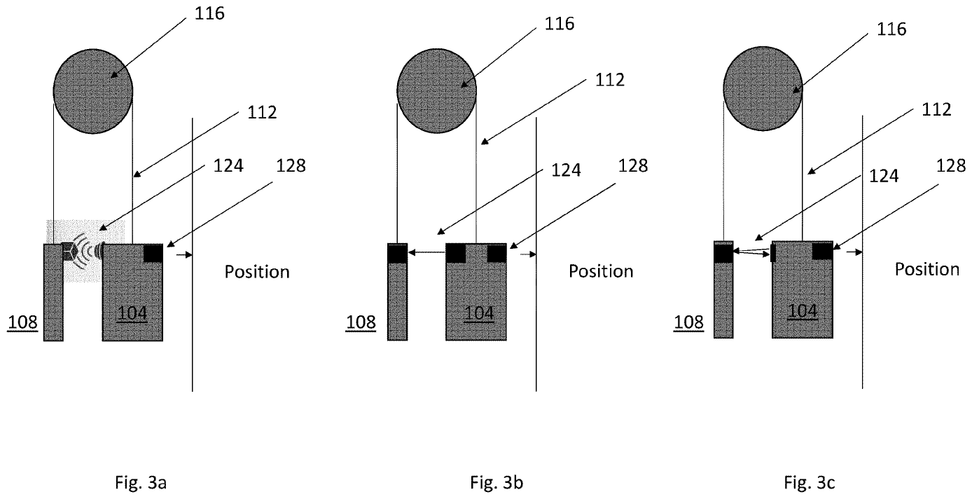

Now referring to FIGS. 3a to 3c, which show exemplary embodiments of sensors arrangements according to the present disclosure.

In FIG. 3a, a sensor arrangement 124 exemplarily is an acoustic sensor arrangement 124 where an acoustic sender, e.g., a loudspeaker, is arranged at one of the elevator car 104 and the counterweight 108, while an acoustic receiver, e.g., a microphone, may be arranged at the other one of the elevator car 104 and the counterweight 108. The acoustic sender may send or emit an acoustic signal into the elevator shaft 118, which may comprise a single or a set of distinctive frequencies, or may generally be noise, e.g., white, pink or brown noise. The acoustic receiver may receive said acoustic signal. Depending on whether the acoustic sender and the acoustic receiver of moving the towards one another or away from one another, a change in the frequency profile of the acoustic signal may occur. In other words, the Doppler effect is employed to determine whether the elevator car 104 and the counterweight 108 are moving towards one another or away from one another. Put another way, the direction of movement itself may not be relevant for the determination of the defined point in time at which the elevator car 104 and the elevator counterweight 108 are at the defined position relative to one another. Rather, the Doppler effect may be employed to determine the point in time where the elevator car 104 and the counterweight 108 are closest to one another, which may be the point of turn, i.e., the point where a moving towards one another shifts to a moving away from one another. Such a determination of the point of turn may be detected by a change in the frequency or frequency profile of the acoustic signal.

The acoustic signal itself may not be required to be known with a high precision, as long as the shift in frequency is detectable and thus the point in time where the elevator car 104 and the elevator car counterweight 108 are at the defined position relative to one another may be determined with sufficient precision.

In FIG. 3b, the sensor arrangement 124 comprises exemplarily a light emitting element and a light receiving element. Here, the elevator car 104 comprises a light-emitting element generally sending an electromagnetic radiation e.g., light or IR light, in the direction where the counterweight 108 would pass the elevator car 104. The light emitted from the light-emitting element may be sufficiently focused on the counterweight 108 so that a precise point in time may be associated with the detection of the emitted light. Alternatively, or additionally, the light receiving element may receive a collimator element or the like, so that only light incident from a closely defined angle is received and/or is employed for detecting the precise point in time where the elevator car 104 and the counterweight 108 are at the defined position relative to one another. Alternatively or additionally, the light-emitting element may be a laser emitter or the like, having a closely focused or narrow beam of light.

In FIG. 3c, the sensor arrangement 124 may be generally comparable to the sensor arrangement 124 of FIG. 3b, with the exception that both the light emitting element and the light receiving element or light detecting element are arranged on one of the elevator car 104 and the counterweight 108. In FIG. 3c, both are exemplarily arranged at the elevator car 104, while the counterweight 108 comprises a reflective element or mirror for reflecting the light emitted from the light emitting element back towards the light receiving element. The reflective element may be comparably small, so that a reflection of the emitted light occurs only within a precisely defined, short time span, so that the point in time where the elevator car 104 and the counterweight 108 are at the defined position relative to one another may be determined with sufficient precision. In other words, the light receiving element may receive a very short pulse from the reflection of the reflective element, e.g., 1 ms, 10 ms, 50 ms, 100 ms, 150 ms, 200 ms or the like, so that the defined point in time can be determined with high precision, and can be repeated subsequently. E.g., an elevator cabin travelling with 1 m/s and registering an impulse of 10 ms would possibly exhibit a position resolution of 1 cm. The resolution may further be improved by registering only the rising or falling edge or the pulse. Also, the resolution may further be improved by distinguishing between upwards or downwards travel. E.g., it is conceivable that the light receiving element only triggers an absolute position determination on a downward travel direction of the elevator car 104, where the counterweight 108 is travelling upwards, triggering the absolute position determination on the rising edge of the detection signal. The inverse behavior or a mix of rising and falling edge detection is also conceivable.

Alternatively, the absolute position determination may be performed over the duration of the pulse trigger signal and the absolute position occurring and determined at the (temporal) center of the pulse may be used as the defined point in time to obtain the absolute position. In order to achieve a pulse like signal, a particular small reflective element may be used, e.g., a circular or rectangular element having a diameter or side length of 20 cm, preferably less than 20 cm, preferably less than 19 cm, preferably less than 18 cm, preferably less than 17 cm, preferably less than 16 cm, preferably less than 15 cm, preferably less than 14 cm, preferably less than 13 cm, preferably less than 12 cm, preferably less than 11 cm, preferably less than 10 cm, preferably less than 9 cm, preferably less than 8 cm, preferably less than 7 cm, preferably less than 6 cm, preferably less than 5 cm, preferably less than 4 cm, preferably less than 3 cm, preferably less than 2 cm, and preferably around 1 cm.

Again, the light-emitting element may be a laser emitter or the like, having a closely focused or narrow beam of light. Having both active elements, the light-emitting elements and the light receiving element, on one of the elevator car 104 and the counterweight 108, in particular on the elevator car 104, provides the benefit that the reflective element may only be a passive element not requiring any electrical connection, and so no electrical connection needs to be provided to the element carrying the reflective element.

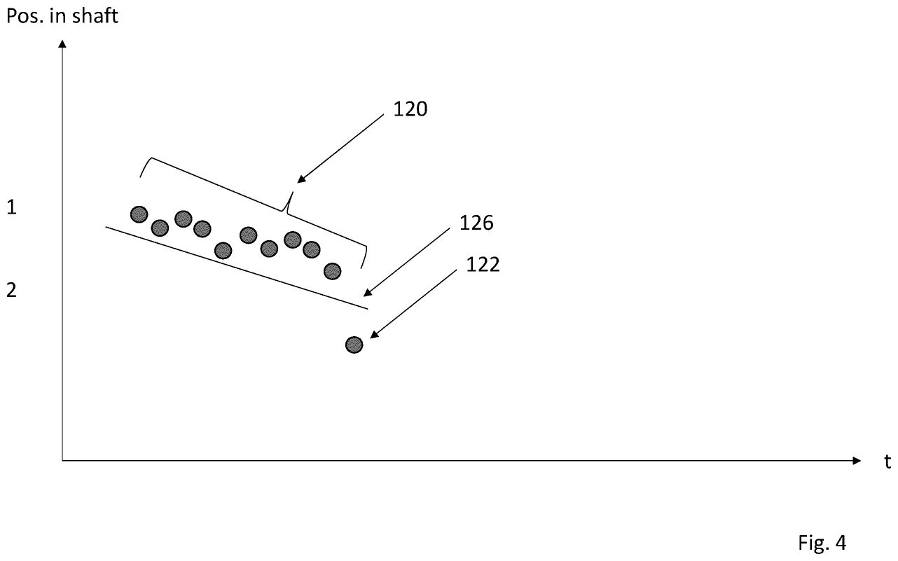

Now referring to FIG. 4, which shows a trend graph of the change of the absolute position at the time of being in the defined relative position to one another of the elevator car 104 and the counterweight 108.

FIG. 4 shows a trend over time of different measurements consisting of a plurality of normal measurements 120 and exemplary one abnormal measurement 122. The measured value may in particular be the absolute position of the car at the defined point in time, i.e., where it meets the counterweight 108. The abnormal measurement 122 is defined by exceeding a threshold 126, here assuming a position below the threshold 126. As can be seen, over time, the individual measurements trend exemplarily from Position 1 towards Position 2. Fluctuations in the individual measurements may be attributed to a different loading of the elevator car 104, which itself provides a certain variability of the current elongation of the traction media 112. To consider aforementioned variability of current elongation due to current load of the elevator car 104, a load sensor 128 is provided which measures the current load. The current load is used to compensate the determined absolute position.

Comprising a load sensor 128 adapted to measure a current load of the elevator car 104, wherein the current load is used to compensate the determined absolute position, in particular the absolute position of the elevator car 104, for elongation variation of the traction medium 112 depending on the current load of the elevator car 104.

Only when the threshold 126 is crossed, the elevator system 100 may determine that an abnormal measurement 122 has been obtained and may thus deduce that the current status of the traction media 112 may also be abnormal, indicating a possible future or imminent malfunction. With the detection of such an abnormal measurement 122, the elevator system 100 may inform a third-party as described previously and/or may put the elevator proactively out of operation, at least until the condition of the traction media 112 has been confirmed, e.g., by a maintenance visit.

It is to be understood that the invention is not limited to the embodiments described above, and various modifications and improvements may be made without deviating from the concepts described here. Any of the features described above and below may be used separately or in combination with any other features described herein, provided they are not mutually exclusive, and the disclosure extends to and includes all combinations and sub-combinations of one or more features described herein.

Finally, it should be noted that the term “comprising” not exclude other elements or steps, and that “a” or “one” does not exclude the plural. Elements that are described in relation to different types of embodiments can be combined. Reference signs in the claims shall not be construed as limiting the scope of a claim.

1.-15. (canceled)

16. An elevator system, comprising:
an elevator car;
a counterweight; and
at least one traction medium connecting the elevator car and the counterweight;
wherein the elevator system determines a position of the elevator car and the counterweight within an elevator shaft;
wherein the position is an absolute position of at least one of the elevator car and the counterweight within the elevator shaft;
wherein the absolute position is determined when the elevator car and the counterweight are determined to be in a defined position within the elevator shaft relative to one another; and
wherein an absolute length and/or a relative elongation of the traction medium is determined from the absolute position.

17. The elevator system according to claim 16, wherein the absolute positions of the elevator car and the counterweight in the elevator shaft are determinable independently.

18. The elevator system according to claim 16, wherein the defined position of the elevator car and the counterweight relative to one another is the position when the elevator car and the counterweight are passing one another in the elevator shaft.

19. The elevator system according to claim 16, further comprising a motor arrangement, the motor arrangement comprising a traction sheave for moving the elevator car and the counterweight in the elevator shaft, wherein the traction sheave is arranged for actuating the at least one traction medium, and wherein the elevator car and the counterweight are suspended in the elevator shaft from the traction sheave by the at least one traction medium.

20. The elevator system according to claim 16, further comprising a sensor arrangement for determining that the elevator car and the counterweight are in the defined position within the elevator shaft relative to one another, wherein the sensor arrangement is preferably provided on at least one of the elevator car and the counterweight.

21. The elevator system according to claim 20, wherein the sensor arrangement comprises a first part provided on the elevator car and a second part provided on the counterweight, wherein the first part and the second part are arranged to interact to determine the defined position of the elevator car and the counterweight within the elevator shaft relative to one another, and wherein the defined position of the elevator car and the counterweight relative to one another is a position when the elevator car and the counterweight are passing one another in the elevator shaft.

22. The elevator system according to claim 21, wherein the first part is emitting a sensor signal and the second part is receiving the sensor signal.

23. The elevator system according to claim 21, wherein the first part is emitting and receiving a sensor signal and the second part is reflecting the sensor signal back towards the first part of the sensor arrangement.

24. The elevator system according to claim 16, wherein the determination of the absolute position of the elevator car and/or the counterweight, and a determination of a passing of the elevator car and the counterweight, are performed independent from one another.

25. The elevator system according to claim 16, further comprising a load sensor to measure a current load of the elevator car, wherein the current load is used in determining the absolute position, and wherein the absolute position of the elevator car depends on the current load of the elevator car when determining the elongation variation of the traction medium.

26. The elevator system according to claim 16, wherein when the absolute length and/or the relative elongation of the traction medium is determined to exceed a defined threshold value, the elevator system provides an indication or transmit a signal to third entity, and/or wherein when the absolute length and/or the relative elongation of the traction medium is determined to exceed the defined threshold value, the elevator system stops operation of the elevator system.

27. A method of monitoring a traction medium of an elevator system, the method comprising:
providing an elevator system, the elevator system comprising:
an elevator car;
a counterweight; and
at least one traction medium connecting the elevator car and the counterweight;
determining a position of the elevator car and the counterweight within an elevator shaft, wherein the position is an absolute position of at least one of the elevator car and the counterweight within the elevator shaft,
determining that the elevator car and the counterweight are in a defined position within the elevator shaft relative to one another; and
determining an absolute length and/or a relative elongation of the traction medium from the absolute position.

28. The method according to claim 27, wherein the defined position of the elevator car and the counterweight relative to one another is the position when the elevator car and the counterweight are passing one another in the elevator shaft.

29. The method according to claim 27, wherein a passing of the elevator car and the counterweight is determined by emitting a sensor signal from a first part of a sensor arrangement, and receiving the sensor signal by a second part of the sensor arrangement.

30. The method according to claim 27, wherein a passing of the elevator car and the counterweight is determined by emitting a sensor signal from a first part of a sensor arrangement, reflecting the sensor signal by a second part of the sensor arrangement back towards the first part of the sensor arrangement, and receiving the sensor signal by the first part of the sensor arrangement.

31. The method according to claim 27, wherein when the absolute length and/or the relative elongation of the traction medium is determined to exceed a defined threshold value, the method further comprises at least one of the steps of providing an indication, transmitting a signal to a third entity, and/or stopping operation of the elevator system.

32. The method according to claim 27, wherein the elevator system further comprises a load sensor to measure a current load of the elevator car, wherein the current load is used in determining the absolute position, and wherein the absolute position of the elevator car depends on the current load of the elevator car when determining the elongation variation of the traction medium.
